(19) United States
(12) Patent Application Publication
(10) Pub. No.: US 2014/0317505 A1
(43) Pub. Date: Oct. 23, 2014

(54) ELECTRONIC DEVICE AND METHOD FOR PRESENTATION OF DOCUMENTS ON VIDEO WALL

(71) Applicant: CHI MEI COMMUNICATION SYSTEMS, INC., New Taipei (TW)

(72) Inventor: PO-YEN LIU, New Taipei (TW)

(73) Assignee: CHI MEI COMMUNICATION SYSTEMS, INC., New Taipei (TW)

(21) Appl. No.: 13/886,960

(22) Filed: May 3, 2013

(30) Foreign Application Priority Data
Apr. 19, 2013 (TW) 102113879

(51) Int. Cl. G06F 3/0484

(52) U.S. Cl. CPC G06F 3/0484
USPC 715/716

(57) ABSTRACT

In a method for presentation of documents on a video wall using an electronic device, a communication connection between the electronic device and the video wall is detected, a dual-screen output function is activated on the video wall, and the documents displayed on a display screen of the electronic device is displayed on the video wall, if the dual-screen output function is activated. The documents is displayed on a main interface and a sub-interface of the video wall, and a touch operation on the sub-interface is received, and executed on the electronic device. Execution results of the touch operation is synchronously displayed on the main interface of the video wall.

### BACKGROUND

1. Technical Field

The embodiments of the present disclosure relate to documents displaying systems and methods, and more particularly to an electronic device and method for presentation of documents on a video wall.

2. Description of Related Art

In recent years, a video wall (e.g., multiple displays configured together) is more and more popular as a tool for presentation of documents while having a meeting or teaching.

However, if the video wall is too big size, a touch area of the video wall may exceed a maximum area that a user can control easily, which may bring inconvenience for presentation of documents on the video wall.

### BRIEF DESCRIPTION OF THE DRAWINGS

FIG. 1 is a block diagram of one embodiment of an electronic device including a document presenting system.

FIG. 2 is a block diagram of one embodiment of function modules of the document presenting system in FIG. 1.

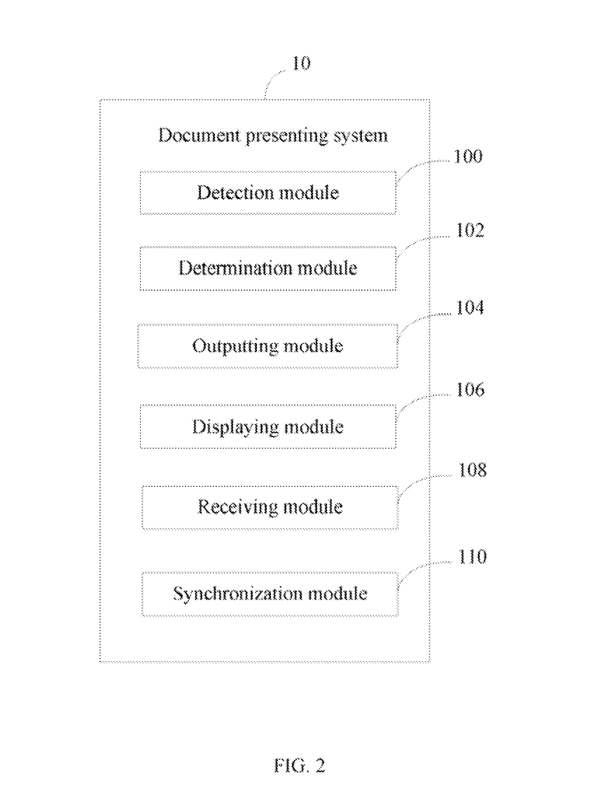

FIG. 3 is a flowchart of one embodiment of a method for presentation of documents on a video wall using the electronic device of FIG. 1.

FIG. 4 is one exemplary of a main interface and a sub-interface of the video wall.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device.

Some non-limiting examples of non-transitory computer-readable media include CDs, DVDs, flash memory, and hard disk drives.

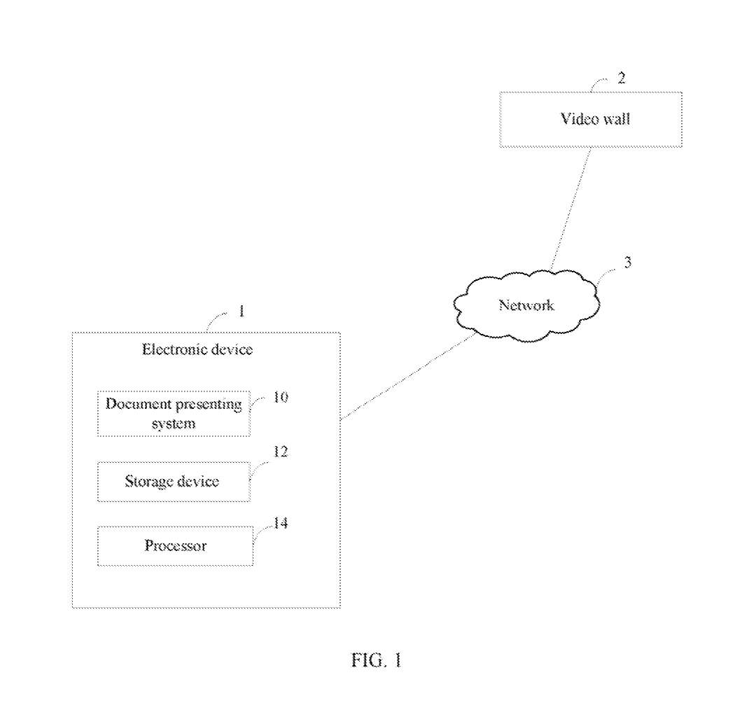

FIG. 1 is a block diagram of one embodiment of an electronic device 1 including a document presenting system 10. In the embodiment, the electronic device 1 communicates with a video wall 2 through a wired or wireless network 3. The electronic device 1 may further include a storage device 12, and at least one processor 14. The electronic device 1 may be a smart phone, a PDA device, or a tablet computer, for example.

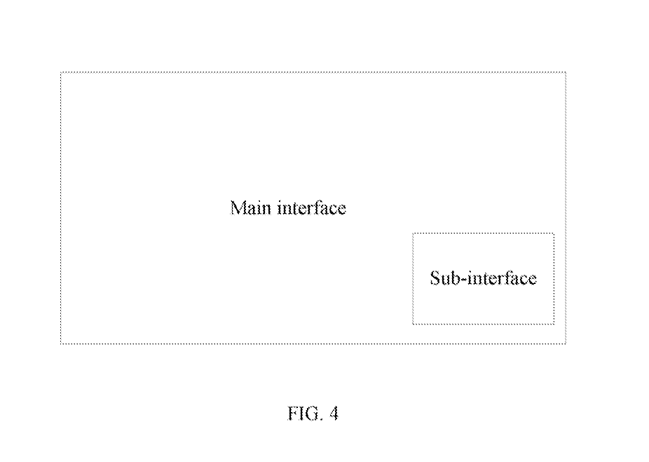

The video wall 2 consists of multiple computer monitors, video projectors, or television sets tiled together contiguously or overlapped in order to form one large screen. The video wall 2 receives one or more documents displayed on a display screen of the electronic device 1, and displays the one or more documents on a main interface and a sub-interface of the video wall 2, as shown in FIG. 4. The sub-interface may cover a portion of the main interface. Furthermore, the main interface or the sub-interface of the video wall 2 may receive a touch operation by a user to control the electronic device 1.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

In one embodiment, the document presenting system 10 includes a plurality of function modules which include computerized codes or instructions that can be stored in the storage device 12 and executed by the at least one processor 14 to provide a method for presentation of documents.

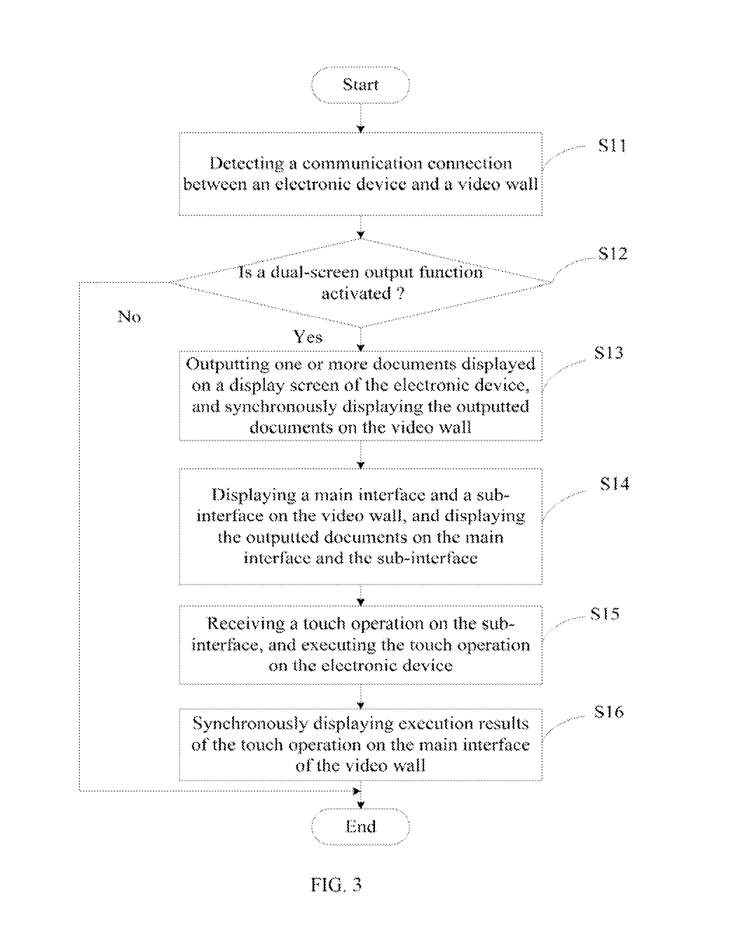

In one embodiment, the document presenting system 10 may include a detection module 100, a determination module 102, an outputting module 104, a displaying module 106, a receiving module 108, and a synchronization module 110. The modules may comprise computerized codes in the form of one or more programs that are stored in the storage device 12 and executed by the at least one processor 14 to provide functions for implementing the modules. The functions of the function modules 100-110 are illustrated in FIG. 3 and described below.

FIG. 3 illustrates a flowchart of one embodiment of a method for presentation of documents on a video wall using the electronic device 1 of FIG. 1. Depending on the embodiment, additional steps may be added, others removed, and the ordering of the steps may be changed.

In block S11, the detection module 100 detects a communication connection between the electronic device 1 and the video wall 2 when the electronic device 1 is powered on. In the embodiment, the communication connection may be a wired or wireless connection through the network 3.

In block S12, the determination module 102 determines whether a dual-screen output function of the electronic device 1 is activated, upon detecting the communication connection between the electronic device 1 and the video wall 2. If the dual-screen output function of the electronic device 1 is activated, step S13 is implemented. Otherwise, if the dual-screen output function of the electronic device 1 is not activated, the procedure ends. In the embodiment, the dual-screen output function may output display data to a screen of the electronic device 1 and the video wall 2 simultaneously. The determination module 102 further displays a selection interface on the display screen of the electronic device 1, and prompts the user whether to activate the dual-screen output function of the electronic device 1 thorough the selection interface. In the embodiment the selection interface is a user interface through which the user of the electronic device 1 may make a selection whether to activate the dual-screen output function of the electronic device 1.

In block S13, the outputting module 104 outputs one or more documents displayed on the display screen of the electronic device 1 to the video wall 2, and synchronously displays the outputted documents on the video wall 2.

In block S14, the displaying module 106 displays a main interface and a sub-interface on the video wall 2, and synchronously displays the outputted documents on the main interface and the sub-interface of the video wall 2.

In block S15, the receiving module 108 receives a touch operation on the sub-interface of the video wall 2, and executes the touch operation on the electronic device 1. In the embodiment, the touch operation may be an editing operation, a storing operation, or a deleting operation on the document, for example.

In block S16, the synchronization module 110 synchronously displays execution results of the touch operation on the main interface of the video wall 2.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a storage device;
at least one processor; and
one or more programs stored in the storage device and executed by the at least one processor, the one or more programs comprising:
a detection module that detects a communication connection between the electronic device and the video wall;
a determination module that determines whether a dual-screen output function of the electronic device is activated upon detecting the communication connection between the electronic device and the video wall;
an outputting module that outputs one or more documents displayed on a display screen of the electronic device to the video wall, and synchronously displays the outputted documents on the video wall, when the dual-screen output function is activated;
a displaying module that displays a main interface and a sub-interface on the video wall, and displays the outputted documents on the main interface and the sub-interface;
a receiving module that receives a touch operation on the sub-interface, and executes the touch operation on the electronic device; and
a synchronization module that synchronously displays execution results of the touch operation on the main interface of the video wall.

2. The electronic device according to claim 1, wherein the determination module further displays a selection interface on the display screen of the electronic device, and prompts a user to activate the dual-screen output function of the electronic device thorough the selection interface.

3. The electronic device according to claim 1, wherein the sub-interface covers a portion of the main interface.

4. The electronic device according to claim 1, wherein the touch operation is an editing operation, a storing operation, or a deleting operation on the documents.

5. A method for presentation of documents on a video wall using an electronic device, the method comprising:
detecting a communication connection between the electronic device and the video wall;
determining whether a dual-screen output function of the electronic device is activated upon detecting the communication connection between the electronic device and the video wall;
outputting one or more documents displayed on a display screen of the electronic device, and synchronously displaying the outputted documents on the video wall, when the dual-screen output function is activated;
displaying a main interface and a sub-interface on the video wall, and displaying the outputted documents on the main interface and the sub-interface;
receiving a touch operation on the sub-interface, and executing the touch operation on the electronic device; and
synchronously displaying execution results of the touch operation on the main interface of the video wall.

6. The method according to claim 5, wherein the method further comprising:
displaying a selection interface on the display screen of the electronic device; and
prompting a user to activate the dual-screen output function of the electronic device thorough the selection interface.

7. The method according to claim 5, wherein the sub-interface covers a portion of the main interface.

8. The method according to claim 5, wherein the touch operation is an editing operation, a storing operation, or a deleting operation on the documents.

9. A non-transitory computer-readable storage medium having stored thereon instructions being executed by a processor of an electronic device, causes the electronic device to perform a method for presentation of documents on a video wall, the method comprising:
detecting a communication connection between the electronic device and the video wall;
determining whether a dual-screen output function of the electronic device is activated upon detecting the communication connection between the electronic device and the video wall is set up;
outputting one or more documents displayed on a display screen of the electronic device, and synchronously displaying the outputted documents on the video wall, when the dual-screen output function is activated;
displaying a main interface and a sub-interface on the video wall, and displaying the outputted documents on the main interface and the sub-interface;
receiving a touch operation on the sub-interface, and executing the touch operation on the electronic device; and
synchronously displaying execution results of the touch operation on the main interface of the video wall.

10. The storage medium according to claim 11, wherein the method further comprising:
displaying a selection interface on the display screen of the electronic device; and
prompting a user to activate the dual-screen output function of the electronic device thorough the selection interface.

11. The storage medium according to claim 11, wherein the sub-interface covers a portion of the main interface.

12. The storage medium according to claim 11, wherein the touch operation is an editing operation, a storing operation, or a deleting operation on the documents.
